(19) United States
(12) Patent Application Publication
(10) Pub. No.: US 2009/0019358 A1
(43) Pub. Date: Jan. 15, 2009

(54) EXTENSIBLE BUSINESS REPORTING LANGUAGE (XBRL) ENABLER FOR BUSINESS DOCUMENTS

(75) Inventors: Robert W. Blake, Lone Tree, CO (US); Emily Huang, Denver, CO (US)

Correspondence Address: MICHAEL A DESANCTIS;HAMILTON DESANCTIS & CHA LLP, FINANCIAL PLAZA AT UNION SQUARE, 225 UNION BOULEVARD, SUITE 305, LAKEWOOD, CO, 80228, US

(73) Assignee: RIVET SOFTWARE, INC. A Delaware Corporation

(21) Appl. No.: 12/193,689

(22) Filed: Aug. 18, 2008

Related U.S. Application Data
(63) Continuation-in-part of application No. 11/163,965, filed on Nov. 4, 2005, now Pat. No. 7,415,482.
(60) Provisional application No. 60/652,210, filed on Feb. 11, 2005.

(51) Int. Cl. G06F 3/14

(52) U.S. Cl. 715/234

(57) ABSTRACT

Methods and systems for improved XBRL tagging and creation of XBRL instance documents are provided. In one embodiment, an XBRL instance document is created based upon an XBRL taxonomy generated based upon multiple base XBRL taxonomies modified to exclude existing XBRL attributes. A portion of a business document is displayed by a business document production application. A portion of the XBRL taxonomy is displayed by a tagging application manager integrated with the business document production application. Responsive to a selection of an XBRL attribute displayed within the XBRL taxonomy and a request to map the selected XBRL attribute to a selected cell or range of business data displayed within the business document, XBRL markup information is created by associating the selected XBRL attribute with the selected business data. An XBRL instance document is then generated based on the XBRL markup information and the business data.

### CROSS-REFERENCE TO RELATED APPLICATIONS

This application is a continuation-in-part of U.S. patent application Ser. No. 11/163,965, filed Nov. 4, 2005, which claims the benefit of U.S. Provisional Patent Application No. 60/652,210, filed Feb. 11, 2005, both of which are hereby incorporated by reference in their entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2005-2008, Rivet Software, Inc.

### BACKGROUND

1. Field

Embodiments of the present invention generally relate to collecting and reporting financial information. In particular, embodiments of the present invention relate to systems and methods of associating XBRL attributes with data in business documents to create marked up documents and producing XBRL instance documents there from.

2. Description of the Related Art

XBRL provides a standard for allowing business data to be exchanged among different computer systems and software applications. XBRL is based upon the extensible Markup Language (XML) and has been developed by a consortium of companies and organizations worldwide (such as accounting firms, trade organizations, software vendors, financial institutions and governments). XBRL provides a basis for users to “tag” or “mark up” data within business documents with standardized classifications or definitions which span a multitude of industry reporting and accounting standards and allow a variety of software applications to understand the meaning and context of the information. As just one example of the use of XBRL, the United States Securities and Exchange Commission (SEC) has recently propose a rule requiring companies—by as early as early 2009—to file financial statements in an “interactive data” (XBRL) format.

As summarized on the XBRL International website:

“The idea behind XBRL is simple. Instead of treating business information as a block of text—as in a standard internet page or a printed document—it provides an identifying tag for each individual item of data. This is computer readable. For example, company net profit has its own unique tag.

The introduction of XBRL tags enables automated processing of business information by computer software, cutting out laborious and costly processes of manual re-entry and comparison. Computers can treat XBRL data “intelligently”: they can recognize the information in a XBRL document, select it, analyze it, store it, exchange it with other computers and present it automatically in a variety of ways for users. XBRL greatly increases the speed of handling of financial data, reduces the chance of error and permits automatic checking of information.

Companies can use XBRL to save costs and streamline their processes for collecting and reporting financial information. Consumers of financial data, including investors, analysts, financial institutions and regulators, can receive, find, compare and analyze data much more rapidly and efficiently if it is in XBRL format.

XBRL can handle data in different languages and accounting standards. It can flexibly be adapted to meet different requirements and uses. Data can be transformed into XBRL by suitable mapping tools or it can be generated in XBRL by appropriate software.”

While the foregoing quote from the XBRL Web-site notes a number of benefits associated with the association of XBRL attributes with data in a business document (which is also known as “tagging”), the accountants and other individuals that generate the business documents for which XBRL tagging is appropriate typically have to associate tagging information with data in their business documents via text/XML editing tools, such as Microsoft® Notepad, or by using complex XBRL-based stand-alone applications that require user to copy/paste, re-key or import data before being able to convert to XBRL.

Consequently, there is a need for tools that allow individuals that generate business documents to associate XBRL attributes with data or locations in their documents that avoids the tagging of information manually via tools like text/XML editors or by using XBRL-based stand-alone applications that are typically difficult for many of the individuals that generate business documents to learn and/or use.

### SUMMARY

Methods and systems are described for improved XBRL tagging and creation of XBRL instance documents. According to one embodiment, a method is provided for creating an extensible Business Reporting Language (XBRL) instance document based upon a single XBRL taxonomy generated based upon multiple base XBRL taxonomies modified to (a) include one or more new XBRL attributes and/or (b) exclude one or more existing XBRL attributes. A portion of a business document containing business data to be tagged is displayed on one or more display devices of a computer system by a business document production application executing on one or more processors of the computer system. At least a portion of the single XBRL taxonomy is displayed on a display device of the one or more display devices by a tagging application manager integrated with the business document production application. Responsive to one or more user input events corresponding to a selection of an XBRL attribute displayed within the portion of the single XBRL taxonomy and corresponding to a request to map the selected XBRL attribute to a selected cell or range of business data displayed within the portion of the business document, XBRL markup information is created by forming an association between the selected XBRL attribute and the selected cell or range of business data. An XBRL instance document is then generated based on the XBRL markup information and the business data.

In the aforementioned embodiment, the business document production application may be a spreadsheet application, including, but not limited to, Microsoft® Excel or the business document production application may be a word processing application, including, but not limited to, Microsoft® Word.

In various instances of the aforementioned embodiments, the one or more user input events may represent a drag and drop in which the selected XBRL attribute is dragged and dropped onto the selected cell or range of business data.

In the context of various of the aforementioned embodiments, the method may further involve signifying the cell or range of business data has XBRL markup data by providing a visual indication associated with the cell or range of business data.

In the aforementioned embodiment, the visual indication may involve highlighting the cell or range of business data with a color.

Other embodiments of the present invention provide a method for merging an XBRL instance document with XBRL markup information. A portion of a business document containing business data to be tagged is displayed on one or more display devices of a computer system by a business document production application executing on one or more processors of the computer system. At least a portion of an XBRL taxonomy is displayed on a display device of the one or more display devices by a tagging application manager integrated with the business document production application. Responsive to one or more user input events corresponding to a selection of an XBRL attribute displayed within the portion of the XBRL taxonomy and corresponding to a request to map the selected XBRL attribute to a selected cell or range of business data displayed within the portion of the business document, XBRL markup information is created by forming an association between the selected XBRL attribute and the selected cell or range of business data. Finally, a modified XBRL instance document is created by merging results of the XBRL markup information and the business data into an existing XBRL instance document.

In the aforementioned embodiment, the business document production application may be a spreadsheet application and the existing XBRL instance document may have been created with a word processing application or vice versa.

Other embodiments of the present invention provide a computer system, which includes a storage device and one or more processors operable to create an XBRL instance document. The storage device has stored therein one or more routines operable to work cooperatively with a concurrently executing business document production application to facilitate tagging of business data of a business document being displayed by the business document production application and generation of the XBRL instance document based thereon. The one or more processors are coupled to the storage device and operable to execute the one or more routines to display at least a portion of an XBRL taxonomy, respond to one or more user input events corresponding to a request to map an XBRL attribute to a cell or range of the business data in a business document being processed by the business production application and generate the XBRL instance document. The request is conveyed by selection of an XBRL attribute displayed within the portion of the XBRL taxonomy and an indication that the selected XBRL attribute is to be associated with the selected cell or range of business data. The tagging of the business data includes forming an association between the selected XBRL attribute and the selected cell or range of business data by inserting into the business document and corresponding to the selected cell or range of business data an identifying tag associated with the selected XBRL attribute. The generation of the XBRL instance document is based on the tagged business data.

In the aforementioned embodiment, the one or more routines may represent a tagging application manager integrated with the business document production application.

In various instances of the aforementioned embodiments, the XBRL taxonomy may be an extension XBRL taxonomy generated based upon multiple base XBRL taxonomies modified to (a) include one or more new XBRL attributes and/or (b) exclude one or more existing XBRL attributes.

In the context of various of the aforementioned embodiments, the generation of the XBRL instance document may involve creating a modified XBRL instance document by merging results of the tagged business data into an existing XBRL instance document.

In the aforementioned embodiment, the business document production application may be a spreadsheet application and the existing XBRL instance document may have been created with a word processing application and vice versa.

Other embodiments of the present invention provide a program storage device readable by a machine, tangibly embodying a program of instructions executable by one or more processors of the machine to perform method steps for creating an extensible Business Reporting Language (XBRL) instance document based upon a single XBRL taxonomy generated based upon multiple base XBRL taxonomies modified to (a) include one or more new XBRL attributes and/or (b) exclude one or more existing XBRL attributes. When the program is executed by the one or more processors, a portion of a business document containing business data to be tagged is displayed on one or more display devices of the machine by a business document production application executing on the one or more processors. At least a portion of the single XBRL taxonomy is displayed on a display device of the one or more display devices by a tagging application manager integrated with the business document production application. Responsive to one or more user input events corresponding to a selection of an XBRL attribute displayed within the portion of the single XBRL taxonomy and corresponding to a request to map the selected XBRL attribute to a selected cell or range of business data displayed within the portion of the business document, XBRL markup information is created by forming an association between the selected XBRL attribute and the selected cell or range of business data. An XBRL instance document is then generated based on the XBRL markup information and the business data.

Other embodiments of the present invention provide a program storage device readable by a machine, tangibly embodying a program of instructions executable by one or more processors of the machine to perform method steps for merging an XBRL instance document with XBRL markup information. A portion of a business document containing business data to be tagged is displayed on one or more display devices of a computer system by a business document production application executing on one or more processors of the computer system. At least a portion of an XBRL taxonomy is displayed on a display device of the one or more display devices by a tagging application manager integrated with the business document production application. Responsive to one or more user input events corresponding to a selection of an XBRL attribute displayed within the portion of the XBRL taxonomy and corresponding to a request to map the selected XBRL attribute to a selected cell or range of business data displayed within the portion of the business document, XBRL markup information is created by forming an association between the selected XBRL attribute and the selected cell or range of business data. Finally, a modified XBRL instance document is created by merging results of the XBRL markup information and the business data into an existing XBRL instance document.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram of a computer environment in which an embodiment of a tagging application manager can be employed;

FIG. 2 is a block diagram of a tagging application manager in accordance with an embodiment of the present invention;

FIG. 3A illustrates the operation of a taxonomy attribute linker associated with the tagging application manager in accordance with an embodiment of the present invention;

FIGS. 3B-3C illustrate the operation of a validation utility in accordance with an embodiment of the present invention;

FIG. 3D illustrates the operation of an export manager in accordance with an embodiment of the present invention;

FIG. 3E illustrates the operation of an XBRL parser in accordance with an embodiment of the present invention;

FIG. 3F illustrates the operation of an attribute collection manager in accordance with an embodiment of the present invention;

FIG. 3G illustrates the operation of an extension manager in accordance with an embodiment of the present invention;

FIG. 4 is a block diagram of a computer environment in which an embodiment of the present invention may operate to facilitate the production of a web form or template form that includes XBRL and that can be presented to an outside entity so that the entity can provide the data that is associated with at least one location in the form with which an attribute has been associated, and once provided, used to generate an XBRL instance document;

FIG. 5 is a block diagram of a tagging application manager that comprises the ability to generate web forms and template forms in accordance with an embodiment of the present invention;

FIG. 6 is a block diagram of a computer environment in which an XBRL translation program in accordance with an embodiment of the present invention may be provided to allow an XBRL document to be translated into a viewable format that is likely to be easier for individuals that are not familiar with the XML/XBRL programming languages or that do not have the time or inclination to become familiar with such languages;

FIG. 7 is a block diagram of an XBRL translation program in accordance with an embodiment of the present invention;

FIG. 8 illustrates the operation of an XBRL translation program in accordance with an embodiment of the present invention in translating an XBRL instance document into a document in which the financial information embedded in the XBRL instance document is likely to be more readily appreciated by individuals unfamiliar with the XML/XBRL programming language syntax present in the instance document;

FIG. 9 is an example of a computer system with which embodiments of the present invention may be utilized.

### DETAILED DESCRIPTION

Methods and systems are described for improved XBRL tagging and creation of XBRL instance documents. For purposes of simplicity, various embodiments of the present invention are described in the context of spreadsheet applications and word processing applications. It is to be noted, however, that the tagging and export functionality described herein may also be provided in connection with other current or future business document production applications, including, but not limited to web-based or online spreadsheets, such as Kyplot, Origin, Quantrix Modeler, Lotus Improv, Ability Spreadsheet, ExcelExplorer, GS-Calc, Mariner Calc, Softmaker Office Planmaker, Spread32, SygmaPlot, The Cruncher, Calc Open, KDCalc, ExcelLite, SpreadsheetGear, 602 Office Tab, Ability Office, Applixware Spreadsheets, AppleWorks, Ashampoo Office PlanMaker, Corel WordPerfect Office Quattro Pro, EasyOffice EasySpreadsheet, Evermore Integrated Office Spreadsheet, Framework, Gobe Spreadsheet, Lotus SmartSuiteLotus 123, Microsoft Works Spreadsheet, Softmaker Office PlanMaker, Open Office Calc, StarOffice Calc, Techdigm Office Calc, Thinkfree Office Spreadsheet, Xoom Office Spreadsheet, JotSpot Tracker, iRows.com, Numsum, ComplyXL, FlyCalc, i-spreadsheet, QuickBase, SecureSheet, Thinkfree, Online Spreadsheet and the like.

Additionally, embodiments of the present invention are applicable to other types of productivity tools or programs designed to perform general computational tasks or organizational tasks in relation to underlying data, including word processing applications, such as Microsoft Word and the like and database applications or database management systems, including, but not limited to 4D, Adabas, Corel Paradox, IBM DB2, FileMaker Pro, FirebirdSQL, IMS, Informix, Ingres, Microsoft Access, Microsoft SQL Server, MySQL, OOo Base, Oracle, PostgreSQL, SQLite, Sybase ASE and the like.

Additionally, while embodiments of the present invention are described with reference to XBRL, it is specifically contemplated that the methods described herein will be applicable to (i) other current and future XBRL-like standards for managing, reporting and/or storing business or analytic data; and/or (ii) other forms of interactive data.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a particular machine, such as a general-purpose or special-purpose processor programmed with the instructions, to perform the steps. Alternatively, the steps may be performed by a combination of hardware, software, firmware and/or by human operators.

Embodiments of the present invention may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

### Terminology

Brief definitions of terms used throughout this application are given below.

The terms “connected” or “coupled” and related terms are used in an operational sense and are not necessarily limited to a direct connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “responsive” includes completely or partially responsive.

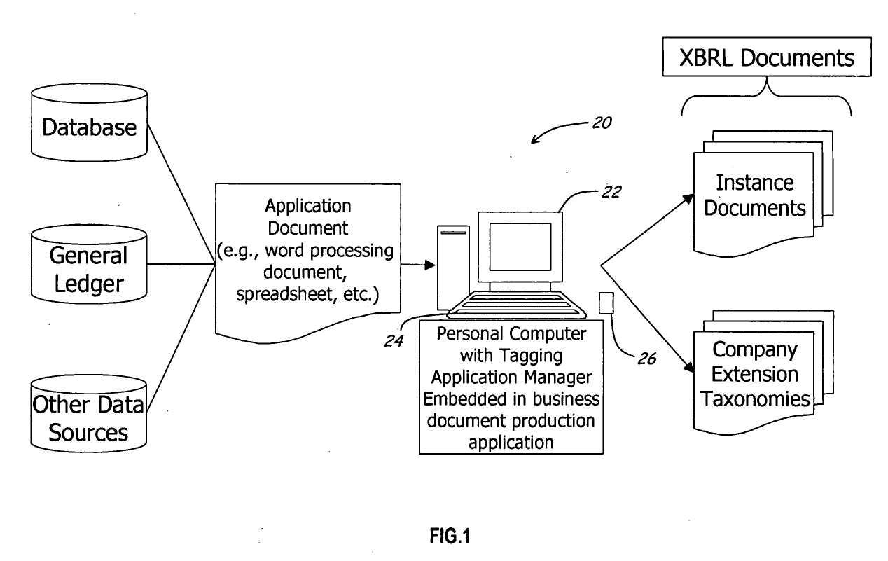

With reference to FIG. 1, a typical computer environment within which a computer program in accordance with an embodiment of the present invention that manages operations associated with tagging or associating of XBRL attributes with locations or target ranges in a business document is illustrated. The program is hereinafter referred to as a tagging application manager. The environment comprises a computer 20 that includes one or more processors that are capable of running or executing a business document production application that allows embedding of the tagging application manager such that, when the business document production application is being executed by the one or more processors, the tagging application manager is also be executed by the processor. Typically, the business document production application and tagging application manager are each stored in a memory associated with the computer 20. For example, the memory may be a disk drive that resides in the computer or a disk drive that is available to the computer 20 via a computer network. The computer 20 is further comprised of a monitor 22 that provides visual information to the user during execution of the business document production application and tagging application manager. While a monitor is the preferred output peripheral, it should be appreciated that use of the application manager is not limited to computers that have monitors. The tagging application manager can be used with other output peripherals. The computer 20 is further comprised of a keyboard 24 and mouse 26, both input peripherals that allow the user to provide input to the tagging application manager. It should be appreciated that operation of the tagging application manager is not dependent upon the use of a keyboard and mouse as the input peripherals. The tagging application manager can be adapted for use with other input peripherals, such as light pens and voice recognition peripherals.

With continuing reference to FIG. 1, when the computer 20 is executing the business document production application with the tagging application manager that may be embedded within or otherwise cooperating with the business document production application, the business document production application is capable of being used to generate business documents, process business documents that were previously produced using the application and then saved, or produced by another instance of the application or a compatible application and imported into the application. In the illustrated embodiment, the business document production application is a Microsoft Office® application, including, but not limited to Microsoft Word or Microsoft Excel, that allows the embedding of the tagging application manager via an event handler or similar structure. It should, however, be appreciated that the tagging application manager is capable of being adapted to be embedded in other business document production applications that provide the capability to embed the program. A business document that is processed by the business document production application typically incorporates data from many other computer sources, such as operational or financial systems, database, and other data sources. In addition, the user of the computer may provide data that is incorporated into the document via the keyboard or other input peripheral. In any event, the business document production application is capable of being used to produce a document that incorporates business data. The tagging application manager that is embedded within the business document production application is capable of being used to produce XBRL instance document and entity (typically, a company) extension taxonomies.

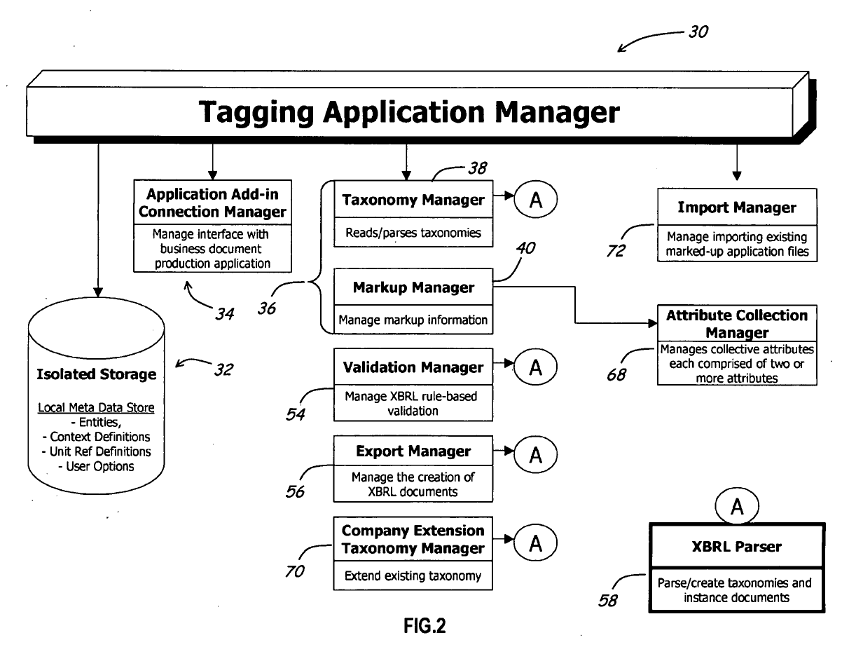

With reference to FIG. 2, a tagging application manager 30 in accordance with an embodiment of the present invention is described in greater detail. In the present example, the tagging application manager 30 is comprised of isolated or dedicated storage 32 for storing certain user specific metadata that is typically used by the manager from one session to the next. In the illustrated embodiment, the storage 32 is used to store entity names, context definitions, unit reference definitions, and user options. Typically, entities are the names of companies or individuals with which one or more XBRL instance documents that have been or are being produced using the manager are associated. Context definitions comprise calendar data, such as the various calendar periods that may be identified within an instance document. Unit reference definitions include the types of units that may apply to an instance document (e.g., dollars, yen, Euros, shares etc.), scaling, and precision definitions. User options define settings selected by the user of the manager that are other than the default settings. For example, the user options can include viewing options (e.g., background colors), export parameters, mark-up characteristics (e.g., the colors used to indicate a selected but untagged location and a selected and tagged location), and user or company extension taxonomies (e.g., taxonomy definitions that are not incorporated into a base or standardized taxonomy, taxonomy overrides and/or taxonomy definitions that prohibit display and/or use of one or more existing attributes of a base or standardized taxonomy).

With continuing reference to FIG. 2, the tagging application manager 30 is further comprised of an add-in connection manager 34 that is used to embed the tagging application manager 30 within the business document production application. In the illustrated embodiment, the manager 34 is adapted to communicate with an operating system event handler, an application program interface utility that manages communications between the manager 34 and a business document production application, including, but not limited to Microsoft® Word and Microsoft Excel. It should be appreciated that the add-in connection manager 34 is capable of being adapted to communicate with other business document production applications that support embedding via a utility that achieves the same function as the event handler. In operation, the add-in connection manager 34 and the event handler cooperate such that when the business document production application is executed or run by the processor in the computer, the tagging application manager is available for use within the business production application manager. In the illustrated embodiment, the tagging application manager is typically accessed via clicking the mouse 26 on an icon for the manger 30 that is established in the business document production application. Once the tagging application manager 30 is accessed, a windows-style interface is established on the monitor 22 that allows the user to interact with the other features or utilities associated with the tagging application manager 30. It should be appreciated that access to the tagging application manager 30 can be provided in many other ways, such as by the user typing in an appropriate command. It should also be appreciated that the function of the add-in connection manager 34 can take other forms in embodiments of the invention in which the manager is native or co-resident with the business document production application.

With continuing reference to FIG. 2, according to the current example, the tagging application manager 30 is further comprised of a taxonomy attribute linker 36 that is comprised of a taxonomy manager 38 and a mark-up manager 40. The taxonomy manager 38 and mark-up manager 40 cooperate or interact with one another in a manner that allows an attribute associated with a taxonomy to be associated with a location in a business document that is being processed by the business document production application. More specifically, the taxonomy manager 38 operates to provide an interface to the monitor 22 that allows the user to select an XBRL taxonomy if more than one taxonomy is available and view a user-selected portion of an XBRL taxonomy on the monitor 22. An XBRL taxonomy is a dictionary comprised of attributes or elements for data that is commonly incorporated into business documents. For example, an XBRL taxonomy may include a net profits attribute or element that is identified by the tag or label “net profit” and that, when associated with a location in a business document, indicates that any data present in that location is defined to be data that reflects a net profit. The mark-up manager 40 operates so as to allow the user to select an attribute from the taxonomy and associate the selected attribute with a particular location or target range in the document.

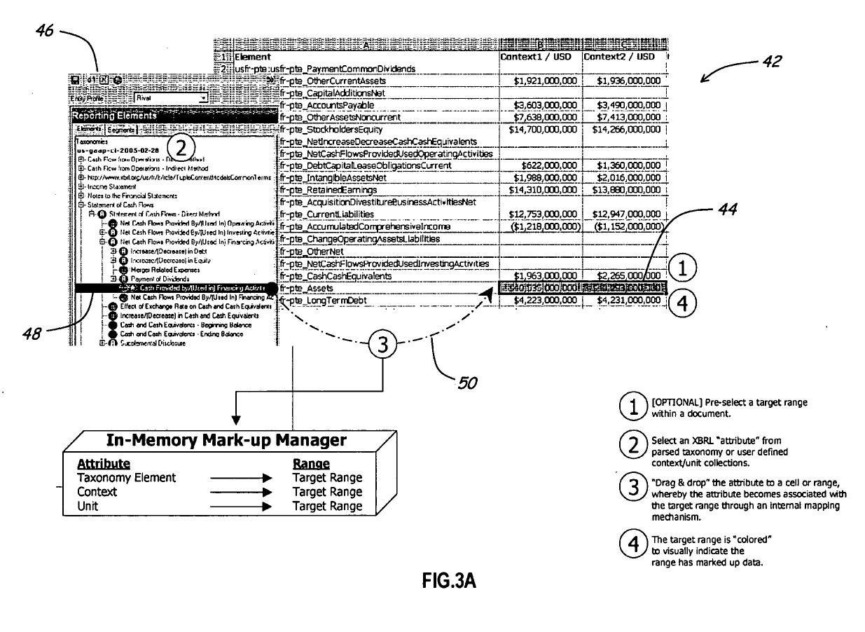

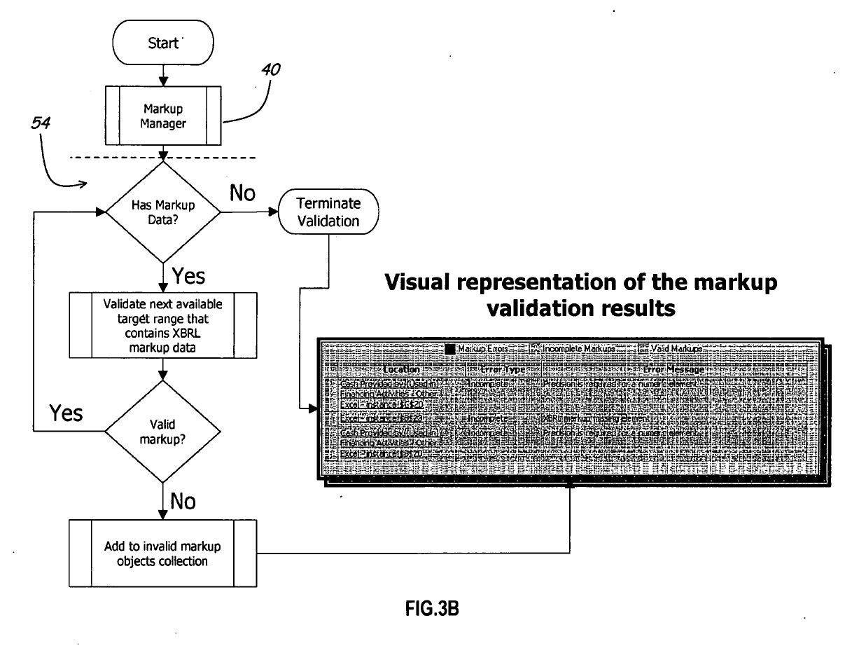

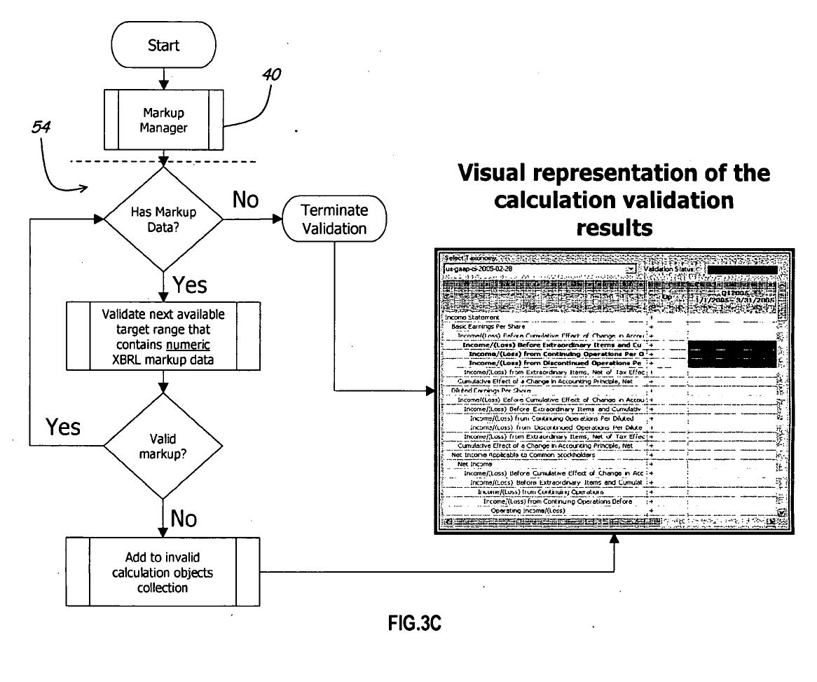

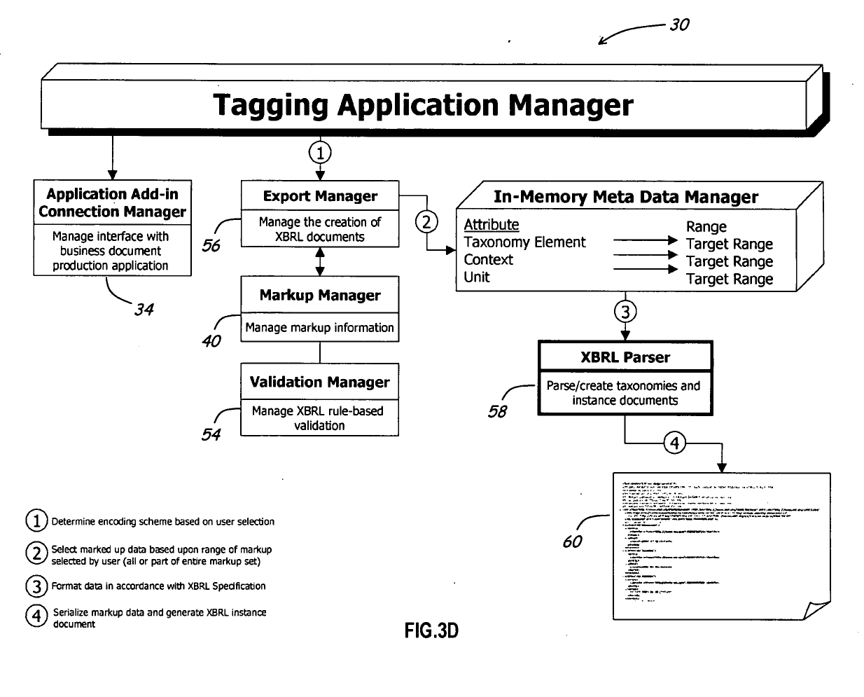

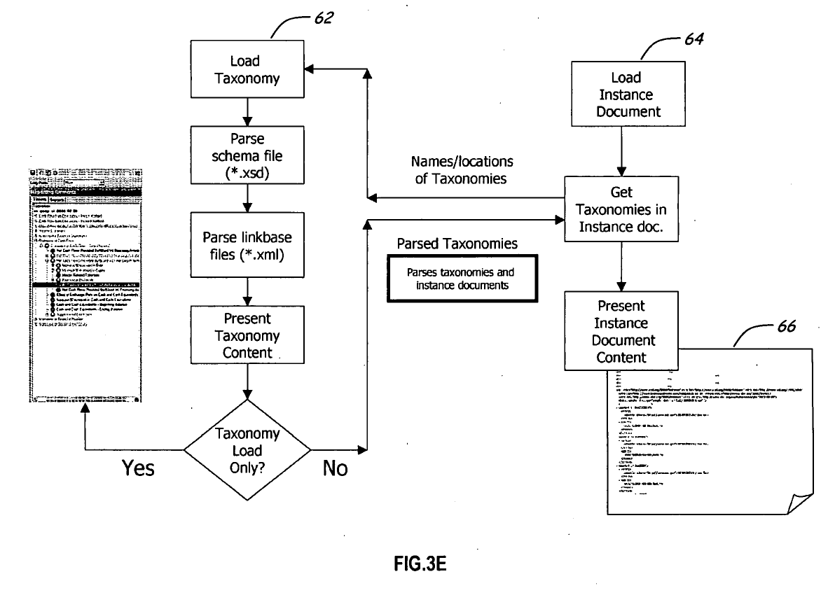

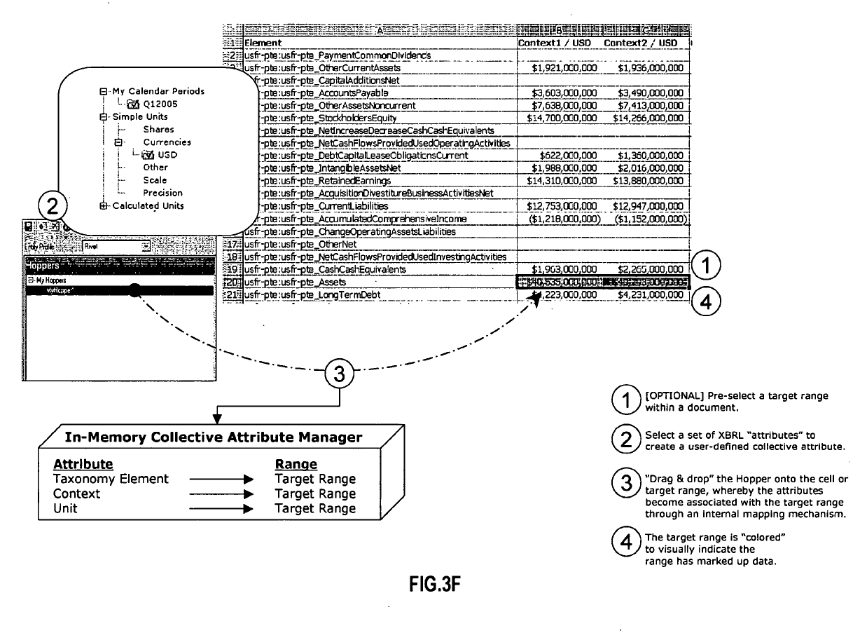

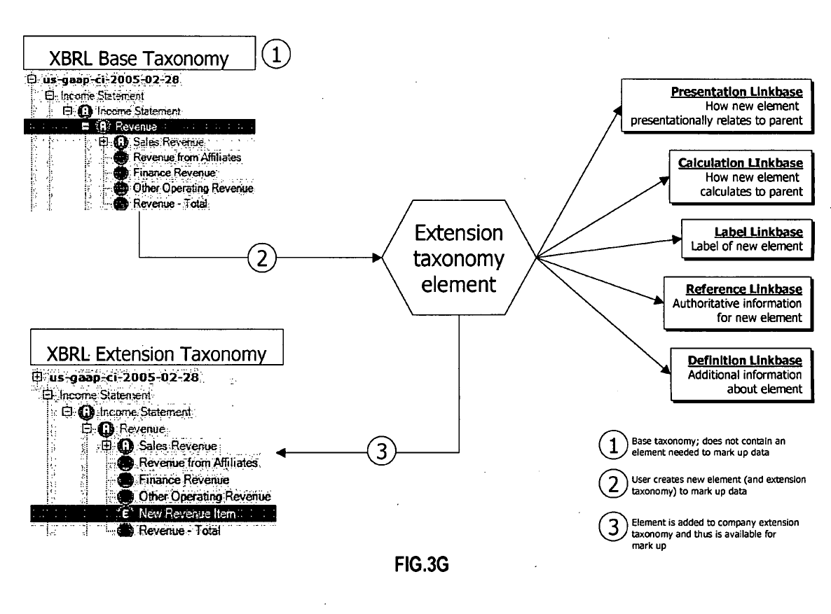

FIG. 3A provides an example of the operation of a taxonomy manager, such as taxonomy manager 38, and a mark-up manager, such as mark-up manager 40, in accordance with an embodiment of the present invention in connection with associating an attribute from an XBRL taxonomy with a location or target range within a Microsoft Excel spreadsheet business document. Depending upon the particular implementation, the various processes, process and/or decision blocks described herein may be performed by hardware components, embodied in machine-executable instructions, which may be used to cause a particular machine, including, but not limited to, a general-purpose or special-purpose processor programmed with the instructions to perform the steps, or the steps may be performed by a combination of hardware, software, firmware and/or involvement of human participation/interaction.

Returning to FIG. 3A, initially, it is assumed that a Microsoft Excel business document is being processed by the Microsoft Excel application and a portion 42 of the document that includes a location or target range with which the user wants to associate an attribute or element is visible to the user on the monitor 22. Next, the user interacts with the markup manager 40 to identify the location or target range 44 in the Microsoft Excel document with which an attribute is to be associated. In the illustrated example, the user utilizes the mouse 26 to highlight a target range of two cells within the spreadsheet as the locations with which an attribute is to be associated. If the taxonomy manager 38 has not already been used to present at least a portion of an XBRL taxonomy 46 that includes the attribute or element that the user wants to associate with the location or target range in the document on the monitor 22, the taxonomy manager 38 is used to present the portion of the XBRL taxonomy 46 on the monitor 22. The user then interacts with the mark-up manager 40 to identify 48 the attribute of the taxonomy that is to be associated with the selected location or target range within the displayed portion 42 of the document by appropriate manipulation of the mouse 26. Finally, the mark-up manager 40 and the user, via manipulation of the mouse 26, interact so as to “drag and drop” the attribute on the selected location or target range within the displayed portion of the document. In the illustrated example, the “Cash Provided by/(Used In) Financing Activities” attribute is associated with the selected two cells of the target range. Typically, the association of an XBRL taxonomy attribute with a location or target range within a document requires that one or more other attributes that are not necessarily associated with the XBRL taxonomy also be associated with the location or target range. In the illustrated example, context and unit attributes are also associated with the locations or target range via the same process as noted with respect to the noted XBRL attribute. Once at least one attribute has been associated with a business document, the document is considered to be a marked-up document.

Note that as implied by the exemplary nature of this illustration, there is no requirement that the above-described steps be performed in any particular order. Furthermore, any of the above steps could be omitted, and other steps could be added where relevant to the specific implementation.

With reference to FIG. 2, the tagging application manager 30 is further comprised of a validation manager 54 that is available to the user for validating a marked-up document prior to the generation of an XBRL instance document. Operation of the validation manager 54 is initiated via the Microsoft Windows®-style interface that is produced on the monitor after the user accesses the tagging application manager 30. Validation of a marked-up document comprises (a) validation of the attribute or attributes associated with a location or target range, (b) validation of the numeric data at a location or target range with which an attribute has been associated, and (c) document-level validation. In the case of validation of the attribute or attributes associated with a location or target range, the validation manager 54 operates to determine: (a) if all of the attributes that need to be associated with the data at a location or target range in the document have been associated with the location or target range and (b) if an attribute has been associated with a location or target range in the document that should not be associated with the location or target range. In the case of validation of numeric data, the validation manager 54 considers each occurrence of marked-up or tagged numeric data in the business to determine whether the numeric data is acceptable or unacceptable based upon the calculation rules identified in the XBRL taxonomy and provide the user with feedback on the results of the validation. For instance, if the amount identified with a “cash” attribute and the amount identified with a “money market” did not add up to the amount identified for “cash and cash equivalents, total” attribute, the validation manager would provide the user with an indication that there was an error with the marked up data. In the case of document level validation the validation manager 54 considers whether unique markup rules per the relevant XBRL taxonomy have been violated. For instance, the validation manager 54 may assess whether there are two or more different values with which the same XBRL attribute has been associated. An example of this would be when a “cash for the first quarter” attribute is associated with data values of 25,000 and 30,000, which renders the document invalid. It should be noted that, due to the integrated nature of the tagging application manager 40, the user is able to use the validation manager 54 to validate a marked up document during the same session that the user employs the other features of the tagging application manager 30, such as the taxonomy attribute linker 36 to markup documents and the export manager 56 to produce XBRL instance documents.

FIG. 3B provides an example of the operation of a validation manager, such as validation manager 54, in accordance with an embodiment of the present invention in connection with validating the attribute or attributes associated with each tagged location or target range in the document. Depending upon the particular implementation, the various processes, process and/or decision blocks described herein may be performed by hardware components, embodied in machine-executable instructions, which may be used to cause a particular machine, including, but not limited to, a general-purpose or special-purpose processor programmed with the instructions to perform the steps, or the steps may be performed by a combination of hardware, software, firmware and/or involvement of human participation/interaction.

As previously noted, operation of the validation manager 54 may be initiated by the user interacting with a graphical user interface, including, but not limited to a windows-style interface, that is presented on the monitor 22 after the tagging application manager 30 is accessed. As shown in FIG. 3B, the user interaction with the windows-style interface to initiate mark-up validation of the document in accordance with an embodiment of the present invention is processed by the mark-up manager 40 calling a validation manager, such as validation manager 54. In response, the validation manager 54 proceeds to search the document for a marked-up location or target range. With respect to a marked up location or target range, the validation manager determines if the markup is invalid or valid. A markup is invalid: (a) if the markup is incomplete (e.g., all of the attributes that need to be associated with a location or target range in the document have not yet been associated with the location or target range), or (b) if the markup is in error (e.g., an attribute has been associated with a location or target range in the document that should not be associated with the location or target range). If the validation manager 54 determines that the markup associated with a location or target range in the document is incomplete and/or in error, the location of the error, error type (e.g., incomplete/in error), and appropriate message are added to a table that is subsequently displayed to the user on the monitor 22. If the markup is not incomplete and not in error, no further action is taken with respect to the markup. After the validation manager has determined that the markup was invalid or valid and added the appropriate information to the table in the case of an invalid error, the validation manager proceeds to search the document for another markup. If another mark-up is identified, the validation manager 54 again determines whether the markup is valid or invalid and, in the case of an invalid markup, adds the appropriate information to the table. The validation manager 54 proceeds in this fashion until each of the marked up locations or target ranges in the document have been analyzed to determine whether the markup is invalid or valid. If, after all of the marked up locations have been analyzed, there are one or more entries in the table, the table is displayed to the user on the monitor. The user is also able to print out the table. If, after all of the marked up location have been analyzed, there are no entries in the table, a note is displayed on the monitor to inform the user that the document is valid with respect to the attribute or attributes associated with each tagged location or target range in the document.

Note that as implied by the exemplary nature of this illustration, there is no requirement that the above-described steps be performed in any particular order. Furthermore, any of the above steps could be omitted, and other steps could be added where relevant to the specific implementation.

FIG. 3C provides an example of the operation of a validation manager, such as validation manager 54, in accordance with an embodiment of the present invention in connection with validating the numeric data associated with each tagged location or target range in the document. Depending upon the particular implementation, the various processes, process and/or decision blocks described herein may be performed by hardware components, embodied in machine-executable instructions, which may be used to cause a particular machine, including, but not limited to, a general-purpose or special-purpose processor programmed with the instructions to perform the steps, or the steps may be performed by a combination of hardware, software, firmware and/or involvement of human participation/interaction.

As previously noted, operation of the validation manager may be initiated by the user interacting with the windows-style interface that is presented on the monitor 22 after the tagging application manager 30 is accessed. As shown in FIG. 3C, the user interaction with the windows-style interface to initiate numeric validation of the document in accordance with an embodiment of the present invention is processed by the mark-up manager 40 calling a validation manager, such as validation manager 54. In response, the validation manager 54 proceeds to search the document for a marked-up location or target range that contains numeric data. With respect to a marked up location or target range that contains numeric data, the validation manager 54 determines if the numeric data is valid. Numeric data is invalid: (a) if the sign associated with the data does not agree with the attribute and/or the sign of the data with which a parent attribute is associated (e.g., negative numeric data that is tagged as profit) or (b) if the value of the numeric data does not agree with other tagged numeric data or calculations based upon other tagged numeric data (e.g., the amount identified with a “cash” attribute and the amount identified with a “money market” attribute do not add up to the amount identified with a “cash and cash equivalent total” attribute. If the validation manager 54 determines that the numeric data associated with a location or target range in the document is or appears to be in error, numeric data and associated attribute are added to a table that is subsequently displayed to the user on the monitor 22. If the numeric data is not or does not appear to be in error, no further action is taken with respect to the numeric data. After the validation manager has determined that the numeric data associated with a particular location or target range is invalid or valid and added the appropriate information to the table in the case of an error or apparent error, the validation manager proceeds to search the document for another occurrence of marked up numeric data. If another instance of mark-up numeric data is identified, the validation manager 54 again determines whether the numeric data is valid or invalid and, in the case of an numeric data that is in error or apparently in error, adds the appropriate information to the table. The validation manager 54 proceeds in this fashion until each instance of marked up numeric data has been analyzed to determine whether the numeric data is invalid or valid. If, after all of the marked up numeric data has been analyzed, there are one or more entries in the table, the table is displayed to the user on the monitor. The user is also able to print out the table. If, after all of the marked up location have been analyzed, there are no entries in the table, a noted is displayed on the monitor to inform the user is that the document is valid with respect to the attribute or attributes associated with each tagged location or target range in the document.

Note that as implied by the exemplary nature of this illustration, there is no requirement that the above-described steps be performed in any particular order. Furthermore, any of the above steps could be omitted, and other steps could be added where relevant to the specific implementation.

With reference to FIG. 2, the tagging application manager 30 is further comprised of an export manager 56 that processes a marked-up business document to: (a) produce an XBRL instance document that conforms to the XBRL Specification or standard, as such, is capable of being processed by other XBRL applications that also conform to the specification or standard, (b) merge results of a marked up document with an existing XBRL instance document to create a revised or new XBRL instance document and/or (c) transmit XBRL instance documents to a recipient. In one embodiment, operation of the export manager 56 is initiated via the windows-style interface that is produced on the monitor after the user accesses the tagging application manager 30. Generally, the export manager 56 operates so as to identify the marked up data in the document of interest, format the marked up data according to the XBRL specification, serialize the formatted data to create a new XBRL instance document or update an existing XBRL instance document, and cause the XBRL instance document to be transmitted to a recipient.

Advantageously, the ability to merge an existing XBRL instance document with result of processing a marked up document supports the ability to receive financial filing information from multiple sources having different formats. For example numeric financial content (e.g., marked up in a spreadsheet application) and non-numeric disclosure and/or notes (e.g., marked up in a word processing application) can be merged into a single XBRL instance document by first exporting either the marked up spreadsheet from the spreadsheet application or the word processing document from the word processing application to create an initial XBRL instance document and then exporting the other to merge the results into a single XBRL instance document.

It should be noted that, in the context of embodiments in which the tagging application manager 30 is integrated with a business document production application, the user is able to use the export manager 70 to produce XBRL instance documents and export such documents during the same session that the user employs the other features of the tagging application manager 30, such as the taxonomy attribute linker 36 to markup documents and the validation manager 54 to validate marked up documents.

FIG. 3D illustrates the operation of an export manager portion of the program in generating an XBRL instance document from a business document that has been marked-up or tagged such that at least one complete set of required attributes is associated with a location or target range within the document in accordance with an embodiment of the present invention. In accordance with the present example, export manager 56 may produce an XBRL instance document that is suitable for transmission to an XBRL-enabled recipient. Depending upon the particular implementation, the various processes, process and/or decision blocks described herein may be performed by hardware components, embodied in machine-executable instructions, which may be used to cause a particular machine, including, but not limited to, a general-purpose or special-purpose processor programmed with the instructions to perform the steps, or the steps may be performed by a combination of hardware, software, firmware and/or involvement of human participation/interaction.

According to the present example, initially, the user identifies to the export manager 56 the desired encoding scheme for the instance document. For example, the user may select from encoding schemes, including, but not limited to, Eight-bit Unicode Transformational Format (UTF-8) and ASCII. Those skilled in the art will recognize that various other encoding schemes are possible. The user also identifies the marked up data in the document that is to be processed to generate the instance document. The export manager 56 uses the markup manager 40 to locate all of the marked up data in the document that is to be processed to generate a new XBRL instance document or supplement an existing XBRL instance document. The export manager 56 also uses the validation manager 54 to ensure that only valid marked up data is processed in generating the XBRL instance document. If the validation manager 54 identifies invalid data, a message is displayed on the monitor and the user is given options as to how to proceed, including the option of exporting whatever portion of the marked up data is valid. The attribute or attributes associated with each of the selected marked-up data are, pursuant to the XBRL Specification, formatted for processing by an XBRL parser 58 (see FIG. 2). The XBRL parser 58 operates to translate the formatted and marked up data into an XBRL instance document, such as document 60, suitable for processing by any XBRL application that conforms to the XBRL Specification.

Note that as implied by the exemplary nature of this illustration, there is no requirement that the above-described steps be performed in any particular order. Furthermore, any of the above steps could be omitted, and other steps could be added where relevant to the specific implementation.

With reference to FIG. 2, the tagging application manager 30 is further comprised of an XBRL parser 58 that operates to: (a) generate or create a taxonomy that is available to the user or (b) both create a taxonomy and generate and XBRL instance document based on the taxonomy. The parser 58 is used by each of the taxonomy manager 38, validation manager 54, and export manager 56 in performing their respective functions. FIG. 3E illustrates the operation of a parser, such as XBRL parser 58, in accordance with an embodiment of the present invention. If the only output required of the parser 58 is the generation of an XBRL taxonomy that can be displayed on the monitor 22 and used in tagging attributes to locations or target ranges in a document, operation of the parser begins with a step 62 in which the taxonomy file of interested is accessed. Subsequently, the schema file and linkbase files that provide the underlying definition of each attribute or element in the taxonomy file are parsed to establish the entire present or current, fully defined taxonomy. This taxonomy is then displayed on the monitor 22 and made available to the user via the windows-style interface that is presented on the monitor 22 after the user selects the tagging application manager 30 within the business document production application. If the parser 58 is needed to generate an instance document, operation of the parser 58 commences with a step 64 in which an instance document is accessed or loaded, the instance document at this point is the formatted file produced when the attribute or attributes associated with each of the selected marked-up data are formatted pursuant to the XBRL specification, as discussed with respect to FIG. 3D. The formatted file identifies the taxonomy or taxonomies that were used in tagging locations or target ranges within the relevant business document. Each of the identified taxonomies is then accessed and established beginning with step 62. After all of the identified taxonomies have be accessed and established, the parser 58 operates to apply each of the identified taxonomies to the formatted instance document to produce a present instance document, such as instance document 66, that is suitable for export.

With reference to FIG. 2, the tagging application manager 30 is further comprised of an attribute collection manager 68 that allows a user to interact with the windows-style interface to define a new attribute that is comprised of two or more previously defined non-XBRL attributes and make the new attribute available to the user for tagging locations or target ranges within a business document. For example, the new attribute can be comprised of a context attribute (e.g., a particular calendar period) and a unit attribute (e.g., US dollars). FIG. 3F illustrates the use of a collective attribute that is a particular type of attribute that is defined to include two or more pre-existing XBRL attributes in accordance with an embodiment of the present invention. According to the present example, an attribute collection manager, such as attribute collection manager 68, is operable to associate an attribute with the label “MyHopper” with two cells within a Microsoft Excel spreadsheet. In one embodiment, the attribute collection manager 68 is called by the markup manager 40. The “MyHopper” labeled attribute is comprised of a calendar period attribute that is defined as the first quarter of 2005 and a unit attribute that is defined as the US dollars. New attributes defined using the attribute collection manager 68 are associated with locations or target ranges in business documents in substantially the same way that taxonomy attributes and other attributes are individually associated with such locations and target ranges. Since the way in which individual attributes are associated with locations and target ranges in a document was previously discussed with respect to FIG. 3A, the association of new attributes comprised of two or more attributes in accordance with an embodiment of the present invention will now be described further. It should be noted that, due to the integrated nature of the tagging application manager 40, the user is able to use the attribute collection manager 68 to define collective attributes during the same session that the user employs the other features of the tagging application manager 30. As a consequence, the user can create a collective attribute and immediately make use of the collective attribute in a document that the user is or wants to mark up during the current session of the tagging application manager 30.

With reference to FIG. 2, the tagging application manager 30 is also comprised of an extension taxonomy manager 70 that allows a user to define an extension taxonomy, which may reflect extensions to, deletions from and/or other modifications of an existing base or standardized XBRL taxonomy. For example the user may define one or more new attributes or elements for an entity/company extension taxonomy that the user can use to supplement an existing XBRL taxonomy and make the new attribute available to the user for tagging locations or target ranges within a business document.

According to various embodiment, the user may also exclude or prohibit display and/or use of one or more existing attributes of the base or standardized XBRL taxonomy to reduce the number of reports/number of attributes from which an end user needs to select. In view of current US GAAP Taxonomies that presently have over 15,000 elements and over 100 reports, it is advantageous to facilitate navigation of the extended taxonomy by allowing such prohibitions/exclusions of attributes and/or reports, which may contain many attributes.

According to one embodiment, to further reduce the complexity for preparers, a preparer may also use the extension taxonomy manager to combine multiple taxonomies into a single extended taxonomy.

FIG. 3G illustrates exemplary operation of an extension taxonomy manager, such as extension taxonomy manager 70 in accordance with an embodiment of the present invention. Initially, the XBRL base taxonomy to which a new XBRL attribute or element is to be added is identified. The user then interacts with the windows-style interface to define the new attribute or element. Specifically, the user interacts with the extension to taxonomy manager 70 to: (a) specify how the new element is going to be presented within the company extension taxonomy relative to the XBRL base taxonomy, e.g., specify the location of the new attribute within the XBRL base taxonomy in a presentation linkbase; (b) specify how the new element that is a numeric element is related or calculated in a calculation linkbase; (c) specify labeling information for the new element in a label linkbase; (d) specify authoritative information for the new element in a reference linkbase; and (e) specify additional information about the new element in a definition linkbase. Once the user has entered all of the information needed to define the new element, the label for the new element or attribute is added to the company extension taxonomy and positioned within the context of the attributes or elements derived from or imported from the XBRL base taxonomy. As a consequence, the new attribute or element is available to be associated with a location or target range within a business document. It should be noted that, due to the integrated nature of the tagging application manger 40, the user is able to use the extension taxonomy manager 68 to define new attributes during the same session that the user employs other features of the tagging application manager 30, such as the taxonomy attribute linker 36 to markup documents. As a consequence, the user can define a new attribute and immediately make use of the new attribute in a document that the user is or wants to mark up during the current session of the tagging application manager 30.

Additionally, in various embodiments of the present invention, as described briefly above, the taxonomy extension manager 70 may more generally provide the user with the ability to modify a base taxonomy. For example, the user may identify and select one or more existing attributes and/or reports in the base taxonomy and communicate through the interface that such selected attributes and/or reports are to be excluded from the extension taxonomy. As a consequence, the excluded attributes, elements and/or reports would no longer be available when the extension taxonomy was displayed in connection with tagging operations. In the context of embodiments in which the tagging application manger 40 is integrated with the business document production application, the user is able to use the extension taxonomy manager 70 to modify attributes during the same session that the user employs other features of the tagging application manager 30, such as the taxonomy attribute linker 36 to markup documents. As a consequence, the user can define new, modify existing and/or exclude existing attributes and the resulting modified taxonomy is immediately reflected during mark up operations in the current session of the tagging application manager 30.

With reference to FIG. 2, the tagging application manager 30 is further comprised of an import manager 72 that provides the user with the ability to import marked-up business documents that were not created during the current session of the tagging application manager 30. Consequently, the import manager 72 provides the ability to import business documents that were marked up during a previous session of the tagging application manager 30 and that require additional work before being used to generate an XBRL instance document or marked-up business documents produced by an application other than the tagging application manager 30 or another instance of the tagging application manager 30. The import manager 72, like the other features of the tagging application manager 30, can be used to import documents during the same session in which other features of the tagging application manager 30 are or may be utilized.

While in the environment of the present example, the tagging application manager 30, the business document production application, the XBRL taxonomies, the business document, the marked up business document and the instance document have been described as if they were residing within or as part of a single personal computer 20, in alternative embodiments one or more of these functional units may be implemented within a separate server accessible by the computer 20. For example one server may be dedicated to tagging and another may be dedicated to generating instance documents.

In the present example, the tagging application manager 30, isolated storage 32, application add-in connection manager 34, taxonomy manager 38, markup manager 40, validation manager 54, export manager 56, company extension taxonomy manager 70, import manager 72, attribute collection manager 68 and XBRL parser 58 have been described as if they resided within or were a part of the computer, such as computer 20, in alternative embodiments some or all of these functional units may be implemented within a separate device. For example, in some embodiments, the business document production application, the tagging application manager functionality or some portion thereof may be provided by way of a local or remote server in the form of a hosted application (e.g., Internet-based application, web-based application, or online application provided by an Application Service Provider (ASPs)). In such a case, the relevant functionality may reside on or be distributed among one or more servers that are accessed through the Internet or a local or wide area network.

In one embodiment, the functionality of one or more of the above-referenced functional units may be further subdivided or merged in various combinations. For example, taxonomy manager 38 and markup manager 40 may be combined. Moreover, the various functional units can be communicatively coupled using any suitable communication method (e.g., message passing, parameter passing, and/or signals through one or more communication paths, etc.). Additionally, the functional units can be physically connected according to any suitable interconnection architecture (e.g., fully connected, hypercube, etc.).

According to embodiments of the invention, the functional units can be any suitable type of logic (e.g., digital logic, firmware, software code and the like) for executing the operations described herein. Any of the functional units used in conjunction with embodiments of the invention can include machine-readable media including instructions for performing operations described herein. Machine-readable media include any mechanism that provides (e.g., stores and/or transmits) information in a form readable by a machine (e.g., a computer). For example, a machine-readable medium includes read only memory (ROM), random access memory (RAM), magnetic disk storage media, optical storage media or flash memory devices.

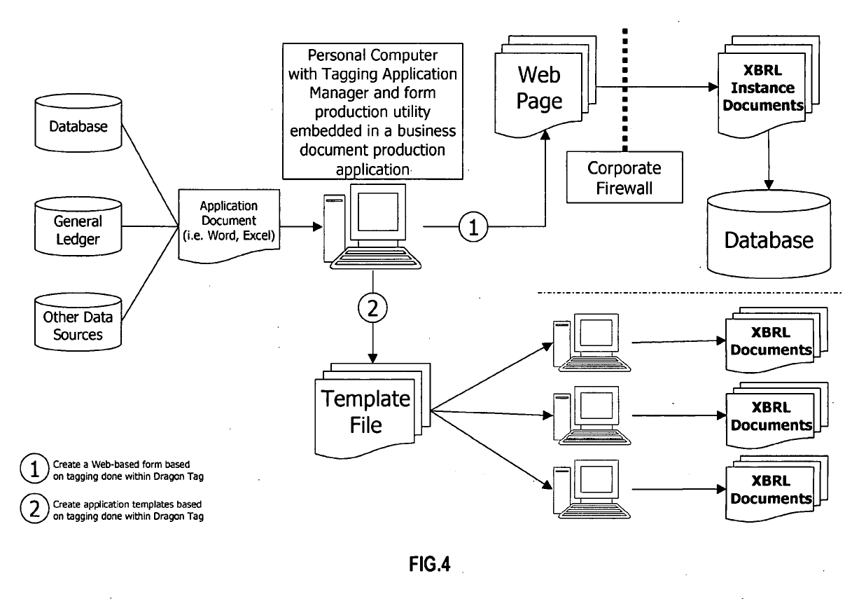

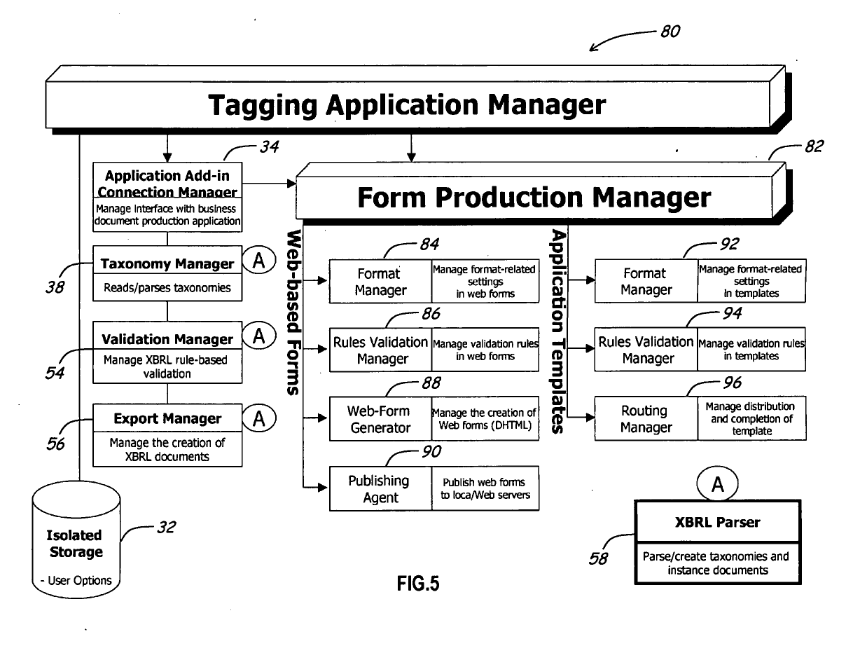

With reference to FIGS. 4 and 5, a tagging application manager in accordance with another embodiment is described that provides the additional capability of being able to generate a marked-up web form into which an outside entity can enter data into the marked up locations. The marked-up form populated with data can then be used to generate XBRL instance documents. In the illustrated embodiment, two types of forms can be generated, a web-based form that an outside entity accesses via the Internet and a template file that is broadcast to one or more outside entities (e.g., other users or consumers). In the case of a web-based form, the outside entity accesses the web-page on which the form is located to create an instance of the form that is associated with the outside entity, provides the data requested by the form, and then submits the instance of the data populated form, which is now a marked-up document that is in the appropriate form for processing by the export manager 56 to produce an XBRL instance document, for processing. In the case of a template file, the template file is provided to an outside entity via an attachment to e-mail or any other convenient means. The outside entity opens the template file, populates the template file with requested data, and then submits the data populated template file that is in the appropriate form for processing by the export manager 56 to produce an XBRL instance document.

With reference to FIG. 5, a tagging application manager 80 is described in accordance with another embodiment of the present invention. The tagging application manager 80 may include all or some portion of the components described with respect to the tagging application manager 30. However, for simplicity, only a subset of the components of the tagging application manager 30 is illustrated. The tagging application manager 80 is further comprised of a form production manager 82 that is capable of generating web-based forms and template forms in which one or more locations or target ranges within a form are tagged with attributes but no data is present in these locations. In the current example, the tagging application manager 80 is embedded in a business document production application that is capable of being used to produce a business document. The production of a form commences with the creation of a business document that is to be the basis for a form in the business document production application or the importing of a business document that is to be the basis for a form into the business document production application. In either case, locations or target ranges within the document are tagged with the appropriate attribute or attributes. However, at least one and typically several locations or target ranges within the document do not contain any data and, as such, are the basis for the “blanks” in the form that is to be subsequently produced. Once the document has been appropriately marked-up and validated, the user causes the document to be applied to the form production manager 82 by appropriate interaction with a windows-style interface that may be provided after the tagging application manager 80 is accessed within the business document production application. The user also makes a choice as to whether a web-based form or an application template form is to be generated.

In the case of a web-based form, the marked-up document is initially applied to a format manager 84 that allows the user to specify how the web form is to look, e.g., locations of the blanks, colors, shading etc. The formatted document is subsequently applied to a rules validation manager 86 that queries the user as to rules that should be applied to each blank in the form. For example, a particular blank may require numeric data. In such a case, the rules validation manager 86 causes a rule to be associated with the blank that alerts an outside entity that has entered non-numeric data into the blank in the resulting web-form and informs the outside entity that only numeric data can be entered in the blank. The formatted form with embedded rules associated with each of the blanks is subsequently applied to a web-form generator 88 that converts the form into a technical format accessible via the Internet, such as HTML or DHTML. The web-form is then provided to a publishing agent 90 that pushes the web-form to a web-server. The web form is then available to one or more outside entities via the Internet. In this regard, an outside entity can access the form and populate the form with data, thereby producing a web-form with marked-up data. The XBRL code within the web-form allows the web-form to produce an XBRL instance document.

In the case of a template form, the marked-up document is initially applied to a format manager 92 that allows the user to specify how the template form is to look, e.g., locations of the blanks, colors, shading etc. The formatted document is subsequently applied to a rules validation manager 94 that queries the user as to rules that should be applied to each blank in the form. For example, a particular blank may require numeric data. In such a case, the rules validation manager 86 causes a rule to be associated with the blank that will alert an outside entity that has entered non-numeric data into the blank in the resulting template form and informs the outside entity that only numeric data can be entered in the blank. The formatted template form with embedded rules associated with each of the blanks is subsequently applied to a routing manager 96 that pushes the template form to outside entities. Once an outside entity has populated the template form with data, the template form can be returned and processed by the export manager 56 to produce an XBRL instance document.

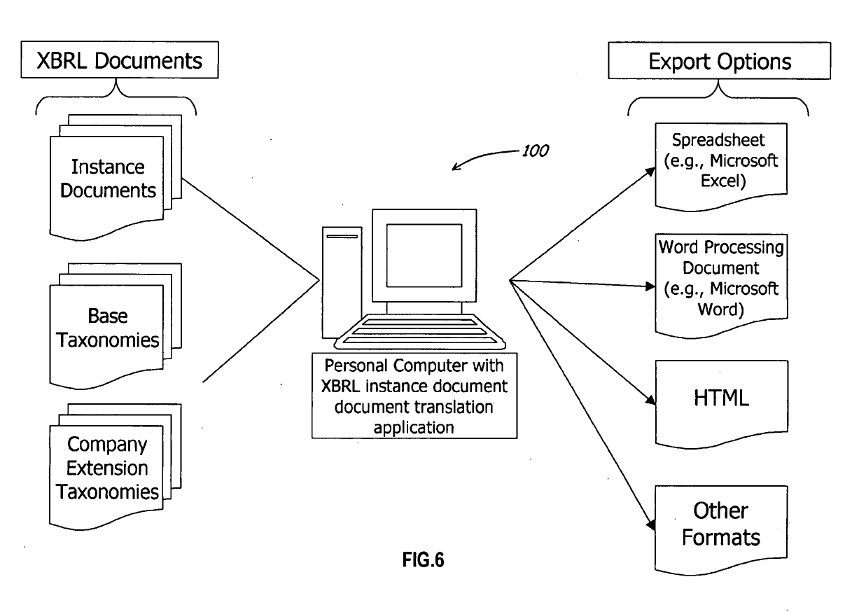

With reference to FIGS. 6-8, an XBRL instance document translation application that is resident on or in a computer readable medium and operates to translates the data that is contained within an XBRL instance document into a viewable format that is more readily understood by many individuals is described in accordance with an embodiment of the present invention. With reference to FIG. 6, the XBRL instance document translation is executed by one or more processors within a computer 100 in accordance with an embodiment of the present invention. The computer 100 comprises input and output peripherals that allow a user to interact with the application. Preferably, the output peripheral on which the viewable format is displayed is a monitor and the input peripherals are a keyboard and a mouse. Other input and output peripherals are also feasible. Generally, the translation application operates to translate an XBRL instance document into a format that, when displayed, is more readily appreciated by users that are unfamiliar with XML/XBRL programming language and do not have the time or inclination to become familiar with the XML/XBRL programming language. In this regard, the translation application is capable of translating an XBRL instance document into any number of formats, including, but not limited to, Microsoft Excel and Microsoft Word formats.

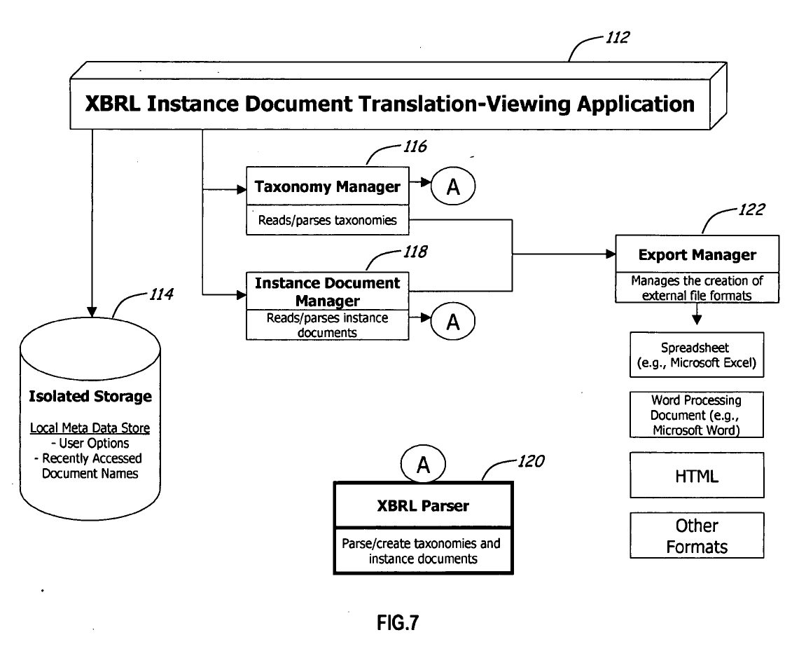

With reference to FIG. 7, a translation application 112 in accordance with an embodiment of the present invention is comprised of isolated or dedicated computer storage 114 that retains data that is or may be useful from one session to another of the application. The translation application 112 is further comprised of a taxonomy manager 116 that reads or obtains the taxonomy or taxonomies associated with a particular XBRL instance document that is to be translated and a an instance document manager 118 that reads/parses the relevant XBRL instance document that the user wants to have translated. The taxonomy manager 116 utilizes an XBRL parser 120 to load the present taxonomy content for each taxonomy used to build the relevant instance document. After the relevant taxonomy or taxonomies have been loaded and the relevant instance document read, an export manager uses the relevant taxonomy or taxonomies and the instance document to generate an export document that is in Microsoft Excel, Microsoft Word, HTML, or some other format that is readily comprehensible to most all individuals regardless of their familiarity with the XML/XBRL programming languages.

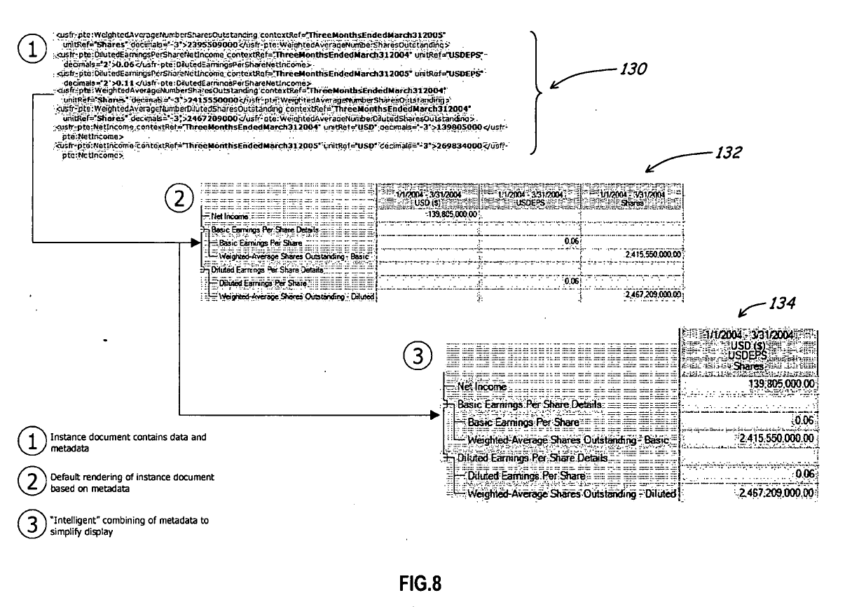

FIG. 8 illustrates an example of the operation of the translation application 112 in accordance with an embodiment of the present invention. Depending upon the particular implementation, the various processes, process and/or decision blocks described herein may be performed by hardware components, embodied in machine-executable instructions, which may be used to cause a particular machine, including, but not limited to, a general-purpose or special-purpose processor programmed with the instructions to perform the steps, or the steps may be performed by a combination of hardware, software, firmware and/or involvement of human participation/interaction.

According to the current example, an instance document 130 and all taxonomies relevant to the instance document are applied to the translation application 112. An XBRL instance document is comprised of attributes associated with numeric and/or non-numeric business report data. These attributes allow an instance document to differentiate between reporting concepts such as “shares” and “dollars” and “earnings per share.” These attributes lead to presentation of the information as shown in the instance document 130. In response to the application of an instance document and related taxonomy or taxonomies, the translation application may produce an intermediate document 132 that is formatted based on the metadata within the XBRL instance document. However, the translation application is also able to produce a document that is easier for most individuals to read and/or comprehend. Specifically, by consolidating the calendar information associated with these attributes, the translation application is able to combine or group attributes that allow the instance document data to be displayed in a report-like format, an example of which shown in document 134. Document 134 has a format more like the original report from which the XBRL data was created.

In some embodiments, the translation application 112 may also include the ability to capture rich-text formatted data, including, but not limited to HTML-formatted content, in the instance document 130. Assuming the rendering software has the ability to distinguish between plain-text and rich-text, when the instance document 130 is rendered, the document can be presented as the preparer intended.

Note that as implied by the exemplary nature of this illustration, there is no requirement that the above-described steps be performed in any particular order. Furthermore, any of the above steps could be omitted, and other steps could be added where relevant to the specific implementation.

While in the environment of the present example, the tagging application manager 80, the form production manager 82, the business document production application, the XBRL taxonomies, the business document, the marked up business document and the instance document have been described as if they were residing within or as part of a single personal computer 100, in alternative embodiments one or more of these functional units may be implemented within a separate server accessible by the computer 100.

In the present example, the tagging application manager 80, isolated storage 32, application add-in connection manager 34, taxonomy manager 38, validation manager 54, export manager 56, format manager 84, rules validation manager 86, web-form generator 88, publishing agent 90, format manager 92, rules validation manager 94, routing manager 96 and XBRL parser 58 have been described as if they resided within or were a part of the computer, such as computer 100, in alternative embodiments some or all of these functional units may be implemented within one or more separate devices. For example, in some embodiments, the tagging application manager functionality, the form production manager functionality or some portion thereof may be provided by way of a web service.

In one embodiment, the functionality of one or more of the above-referenced functional units may be further subdivided or merged in various combinations. Moreover, the various functional units can be communicatively coupled using any suitable communication method (e.g., message passing, parameter passing, and/or signals through one or more communication paths, etc.). Additionally, the functional units can be physically connected according to any suitable interconnection architecture (e.g., fully connected, hypercube, etc.).

According to embodiments of the invention, the functional units can be any suitable type of logic (e.g., digital logic, firmware, software code and the like) for executing the operations described herein. Any of the functional units used in conjunction with embodiments of the invention can include machine-readable media including instructions for performing operations described herein. Machine-readable media include any mechanism that provides (e.g., stores and/or transmits) information in a form readable by a machine (e.g., a computer). For example, a machine-readable medium includes read only memory (ROM), random access memory (RAM), magnetic disk storage media, optical storage media or flash memory devices.

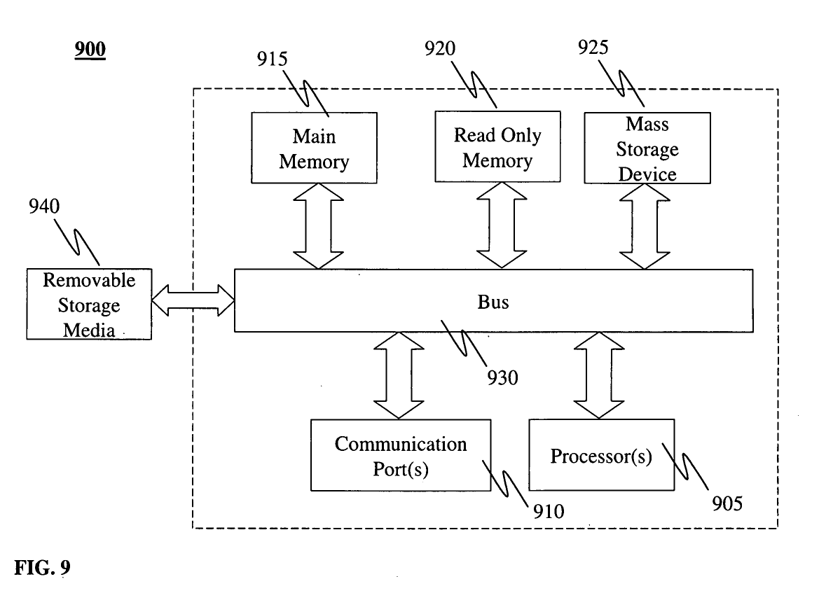

FIG. 9 is an example of a computer system with which embodiments of the present invention may be utilized. The computer system 900 may represent or form a part of computer 20, computer 100, an application server, a web server, a client workstation and/or other devices implementing some subset of functionality of the tagging application manager 30, the tagging application manager 80, the form production manager 82 or other of the functional units depicted in FIGS. 2 and/or 8. According to FIG. 9, the computer system 900 includes one or more processors 905, one or more communication ports 910, main memory 915, read only memory 920, mass storage 925, a bus 930, and removable storage media 940.

The processor(s) 905 may be Intel® Itanium® or Itanium 2® processor(s), AMD® Opteron® or Athlon MP® processor(s) or other processors known in the art.

Communication port(s) 910 represent physical and/or logical ports. For example communication port(s) 910 may be any of an RS-232 port for use with a modem based dialup connection, a 10/100 Ethernet port, or a Gigabit port using copper or fiber. Communication port(s) 910 may be chosen depending on a network such a Local Area Network (LAN), Wide Area Network (WAN), or any network to which the computer system 900 connects.

Communication port(s) 910 may also be the name of the end of a logical connection (e.g., a TCP port or a Universal Datagram Protocol (UDP) port). For example communication ports may be one of the Well Known Ports, including, but not limited to, as TCP port 25 (used for Simple Mail Transfer Protocol (SMTP)) and TCP port 80 (used for HTTP service), assigned by the Internet Assigned Numbers Authority (IANA) for specific uses.

Main memory 915 may be Random Access Memory (RAM), or any other dynamic storage device(s) commonly known in the art.

Read only memory 920 may be any static storage device(s) such as Programmable Read Only Memory (PROM) chips for storing static information such as instructions for processors 905.

Mass storage 925 may be used to store information and instructions. For example, hard disks such as the Adaptec® family of SCSI drives, an optical disc, an array of disks such as RAID, such as the Adaptec® family of RAID drives, or any other mass storage devices may be used.

Bus 930 communicatively couples processor(s) 905 with the other memory, storage and communication blocks. Bus 930 may be a PCI/PCI-X or SCSI based system bus depending on the storage devices used.

Optional removable storage media 940 may be any kind of external hard-drives, floppy drives, IOMEGA® Zip Drives, Compact Disc-Read Only Memory (CD-ROM), Compact Disc—Re-Writable (CD-RW), Digital Video Disk (DVD)—Read Only Memory (DVD-ROM), Re-Writable DVD and the like.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
displaying on one or more display devices of a computer system by a business document production application executing on one or more processors of the computer system at least a portion of a business document containing business data to be tagged;
displaying on a display device of the one or more display devices by a tagging application manager integrated with the business document production application at least a portion of a single extensible Business Reporting Language (XBRL) taxonomy generated based upon a plurality of base XBRL taxonomies and modified to exclude one or more existing XBRL attributes;
responsive to one or more user input events corresponding to a selection of an XBRL attribute displayed within the portion of the single XBRL taxonomy and corresponding to a request to map the selected XBRL attribute to a selected cell or range of business data displayed within the portion of the business document, creating XBRL markup information by forming an association between the selected XBRL attribute and the selected cell or range of business data; and
generating an XBRL instance document based on the XBRL markup information and the business data.

2. The method of claim 1, wherein the business document production application comprises a spreadsheet application.

3. The method of claim 2, wherein the spreadsheet application comprises Microsoft® Excel.

4. The method of claim 1, wherein the business document production application comprises a word processing application.

5. The method of claim 4, wherein the word processing application comprises Microsoft® Word.

6. The method of claim 1, wherein the one or more user input events represent a drag and drop in which the selected XBRL attribute is dragged and dropped onto the selected cell or range of business data.

7. The method of claim 1, further comprising signifying the cell or range of business data has XBRL markup data by providing a visual indication associated with the cell or range of business data.

8. The method of claim 7, wherein the visual indication comprises highlighting the cell or range of business data with a color.

9. A method comprising:
displaying on one or more display devices of a computer system by a business document production application executing on one or more processors of the computer system at least a portion of a business document containing business data to be tagged;
displaying on a display device of the one or more display devices by a tagging application manager integrated with the business document production application at least a portion of an extensible Business Reporting Language (XBRL) taxonomy;
responsive to one or more user input events corresponding to a selection of an XBRL attribute displayed within the portion of the XBRL taxonomy and corresponding to a request to map the selected XBRL attribute to a selected cell or range of business data displayed within the portion of the business document, creating XBRL markup information by forming an association between the selected XBRL attribute and the selected cell or range of business data; and
creating a modified XBRL instance document by merging results of the XBRL markup information and the business data into an existing XBRL instance document.

10. The method of claim 1, wherein the business document production application comprises a spreadsheet application and the existing XBRL instance document was created with a word processing application.

11. The method of claim 1, wherein the business document production application comprises a word processing application and the existing XBRL instance document was created with a spreadsheet application.

12. A computer system comprising:
a storage device having stored therein one or more routines operable to work cooperatively with a concurrently executing business document production application to facilitate tagging of business data of a business document being displayed by the business document production application and generation of an extensible Business Reporting Language (XBRL) instance document based thereon; and
one or more processors coupled to the storage device and operable to execute the one or more routines to display at least a portion of an XBRL taxonomy, respond to one or more user input events corresponding to a request to map an XBRL attribute to a cell or range of the business data in a business document being processed by the business production application and generate the XBRL instance document, where
the request is conveyed by selection of an XBRL attribute displayed within the portion of the XBRL taxonomy and an indication that the selected XBRL attribute is to be associated with the selected cell or range of business data;
the tagging of the business data includes forming an association between the selected XBRL attribute and the selected cell or range of business data by inserting into the business document and corresponding to the selected cell or range of business data an identifying tag associated with the selected XBRL attribute; and
the generation of the XBRL instance document is based on the tagged business data.

13. The computer system of claim 12, wherein the one or more routines comprise a tagging application manager integrated with the business document production application.

14. The computer system of claim 12, wherein the XBRL taxonomy is an extension XBRL taxonomy generated based upon a plurality of base XBRL taxonomies modified to (a) include one or more new XBRL attributes or (b) exclude one or more existing XBRL attributes.

15. The computer system of claim 12, wherein the generation of the XBRL instance document comprises creating a modified XBRL instance document by merging results of the tagged business data into an existing XBRL instance document.

16. The computer system of claim 15, wherein the business document production application comprises a spreadsheet application and the existing XBRL instance document was created with a word processing application.

17. The computer system of claim 15, wherein the business document production application comprises a word processing application and the existing XBRL instance document was created with a spreadsheet application.

18. A computer system comprising:
a storage means for storing one or more routines operable to work cooperatively with a concurrently executing business document production application to facilitate tagging of business data of a business document being displayed by the business document production application and generation of an extensible Business Reporting Language (XBRL) instance document based thereon; and
one or more processing means coupled to the storage means for executing the one or more routines to display at least a portion of an XBRL taxonomy, respond to one or more user input events corresponding to a request to map an XBRL attribute to a cell or range of the business data in a business document being processed by the business production application and generate the XBRL instance document, where
the request is conveyed by selection of an XBRL attribute displayed within the portion of the XBRL taxonomy and an indication that the selected XBRL attribute is to be associated with the selected cell or range of business data;
the tagging of the business data includes forming an association between the selected XBRL attribute and the selected cell or range of business data by inserting into the business document and corresponding to the selected cell or range of business data an identifying tag associated with the selected XBRL attribute; and
the generation of the XBRL instance document is based on the tagged business data.

19. A method comprising:
a first presentation step for displaying on one or more display devices of a computer system by a business document production application executing on one or more processors of the computer system at least a portion of a business document containing business data to be tagged;
a second presentation step for displaying on a display device of the one or more display devices by a tagging application manager integrated with the business document production application at least a portion of a single extensible Business Reporting Language (XBRL) taxonomy generated based upon a plurality of base XBRL taxonomies modified to exclude one or more existing XBRL attributes;
a mapping step, responsive to one or more user input events corresponding to a selection of an XBRL attribute displayed within the portion of the single XBRL taxonomy and corresponding to a request to map the selected XBRL attribute to a selected cell or range of business data displayed within the portion of the business document, for creating XBRL markup information by forming an association between the selected XBRL attribute and the selected cell or range of business data; and
an export step for generating an XBRL instance document based on the XBRL markup information and the business data.

20. A method comprising:
a first presentation step for displaying on one or more display devices of a computer system by a business document production application executing on one or more processors of the computer system at least a portion of a business document containing business data to be tagged;
a second presentation step for displaying on a display device of the one or more display devices by a tagging application manager integrated with the business document production application at least a portion of an extensible Business Reporting Language (XBRL) taxonomy;
a mapping step, responsive to one or more user input events corresponding to a selection of an XBRL attribute displayed within the portion of the XBRL taxonomy and corresponding to a request to map the selected XBRL attribute to a selected cell or range of business data displayed within the portion of the business document, for creating XBRL markup information by forming an association between the selected XBRL attribute and the selected cell or range of business data; and
an export step for creating a modified XBRL instance document by merging results of the XBRL markup information and the business data into an existing XBRL instance document.

21. A program storage device readable by a machine, tangibly embodying a program of instructions executable by one or more processors of the machine to perform method steps for creating an extensible Business Reporting Language (XBRL) instance document, said method steps comprising:
displaying on one or more display devices of the machine by a business document production application executing on the one or more processors at least a portion of a business document containing business data to be tagged;
displaying on a display device of the one or more display devices by a tagging application manager integrated with the business document production application at least a portion of an extension XBRL taxonomy generated based upon a plurality of base XBRL taxonomies modified to exclude one or more existing XBRL attributes;
responsive to one or more user input events corresponding to a selection of an XBRL attribute displayed within the portion of the extension XBRL taxonomy and corresponding to a request to map the selected XBRL attribute to a selected cell or range of business data displayed within the portion of the business document, creating XBRL markup information by forming an association between the selected XBRL attribute and the selected cell or range of business data; and
generating an XBRL instance document based on the XBRL markup information and the business data.

22. A program storage device readable by a machine, tangibly embodying a program of instructions executable by one or more processors of the machine to perform method steps for creating an extensible Business Reporting Language (XBRL) instance document, said method steps comprising:
displaying on one or more display devices of the machine by a business document production application executing on the one or more processors at least a portion of a business document containing business data to be tagged;
displaying on a display device of the one or more display devices by a tagging application manager integrated with the business document production application at least a portion of an XBRL taxonomy;
responsive to one or more user input events corresponding to a selection of an XBRL attribute displayed within the portion of the XBRL taxonomy and corresponding to a request to map the selected XBRL attribute to a selected cell or range of business data displayed within the portion of the business document,
creating XBRL markup information by forming an association between the selected XBRL attribute and the selected cell or range of business data; and
creating a modified XBRL instance document by merging results of the XBRL markup information and the business data into an existing XBRL instance document.
